(19) United States
(12) Patent Application Publication
(10) Pub. No.: US 2022/0405070 A1
(43) Pub. Date: Dec. 22, 2022

(54) METHOD AND DEVICE FOR MANAGING ACCESSES OF MULTIPLE SOFTWARE COMPONENTS TO SOFTWARE INTERFACES

(71) Applicant: Robert Bosch GmbH, Stuttgart (DE)

(72) Inventors: Joshua-Niclas Oergele, Waldenbuch (DE); Micha Muenzenmay, Stuttgart (DE); Mouham Tanimou, Goeppingen (DE); Tobias Krug, München (DE); Udo Schulz, Vaihingen/Enz (DE)

(21) Appl. No.: 17/773,575

(22) PCT Filed: Oct. 19, 2020
(86) PCT No.: PCT/EP2020/079356

§ 371 Date: Apr. 29, 2022

(30) Foreign Application Priority Data
Nov. 6, 2019 (DE) 10 2019 217 047.1

(51) Int. Cl. G06F 8/41; G06F 8/70

(52) U.S. Cl. CPC G06F 8/443; G06F 8/70

(57) ABSTRACT

A method for managing accesses of multiple software components to software interfaces. In the method, a temporal allocation of the software components to the software interfaces is calculated statically based on requirements of the software components with respect to the software interfaces. The allocation is optimized continuously in light of an observed runtime behavior of the software components.

### FIELD

The present invention relates to a method for managing accesses of multiple software components to software interfaces. In addition, the present invention relates to a corresponding device, a corresponding computer program as well as a corresponding storage medium.

### BACKGROUND INFORMATION

Some conventional methods are available in the related art for the distribution or updating of software (SW) via a wireless data interface—sometimes referred to as “over the air” (OTA). Generic methods are applicable both to application software (SOTA) and to embedded system software (firmware, FOTA).

According to the related art, FOTA and SOTA are utilized, for example, to update the electronic control units (ECUs) of networked motor vehicles and agricultural machinery. In doing so, typically a vehicle connectivity gateway (VCG) is used for the telematic connection between the bus system coupling the electronic control units and the Internet (the figurative “Cloud”).

Beyond the maintenance and bug fixes of software that is already installed, in this way the range of functions of in-vehicle electronic control units may be expanded by features which utilize existing sensors and actuators for new application cases. Corresponding applications may be created by producers or original equipment manufacturers (OEM) of an agricultural machine—perhaps with the aid of a development kit—and offered on a digital marketing platform in the Cloud. For example, advanced telemetry functions or special agricultural functions such as targeted weed control are considered as possible expansions.

German Patent Application No. DE 10 2015 203 766 A1 describes a subsystem for a vehicle having a device-management client, connected via an OTA to a device-management server of the backend, for the exchange of device-, vehicle- and diagnostic-, as well as software update information; a download client, connected via the OTA to a download server of the backend, for downloading a software update from the backend into the vehicle; software-update clients, connected to the download client, for applying the software update; and a vehicle-update client, connected to the download client and the software-update clients, for coordinating the software update.

In the course of independent development, container virtualization or operating-system virtualization, already customary for some time in computing-center operations, is more recently increasingly finding its way into the practice of embedded systems. This method makes it possible to operate multiple instances of an operating system as so-called guests, isolated from one another, on one host system. In this way, the host is able to make available to each application (app) encapsulated within such a container, a complete runtime environment that, for example, may include dynamic libraries of the programming language such as Java, C or Python used by the respective developer. Although this “light-weight” form of the virtualization imposes a few restrictions on the guests compared to the use of a hypervisor, it has the advantage that all containers jointly use the kernel of the native operating system—typically Linux, BSD, Solaris or another Unix-like system. The use of containers thus conserves the scanty resources of embedded systems.

Logical contact points in such a system are referred to commonly as software interfaces or software-based data interfaces and permit the exchange of instructions as well as data between various processes and software components. In addition to data-oriented interfaces used only for communication, functional interfaces are familiar which synchronize or support the primary participating software components. Some interfaces even permit an inter-process communication (IPC) in distributed systems. IPC interfaces of this conventional kind include RPC, DCOM, RMI or message brokers such as CORBA, for example, or MQTT used in telemetry.

### SUMMARY

The present invention provides a method for managing accesses of multiple software components to software interfaces, a corresponding device, a corresponding computer program as well as a corresponding storage medium.

One advantage of this approach in accordance with the present invention lies in the improved interface handling of intrinsically dynamically behaving systems, so that a resource management and the guarantee of an anticipated system behavior (e.g., with respect to functional controlled systems and the control response associated with them) is also provided with regard to functional safety.

Advantageous further developments of and improvements to the basic features of the present invention are made possible by the measures disclosed herein. Thus, the temporal allocation of the access of software components to software interfaces may be optimized on the basis of higher-level system goals. For example, one corresponding specific embodiment of the present invention enables the optimization and orchestration of interface requests based on a calculation of bandwidth requirement (accesses per unit of time), access duration, priorities, real-time goals and updating rates. This also includes the management of interfaces in terms of their arbitration and availability, thus, the brokering between interface supply and demand. The estimated bandwidth requirement corresponds to the sum of all interface requirements defined in the manifests of the individual software components and is also specific to the system morphology—for instance, in the case of a valve control, the number of existing solenoid valves. Naturally, this requirement is only a provisional assessment, since it does not take into account changes, user interaction and other events at runtime. In the case of the interface requirement of further optional functions going beyond the basic functions, it is checked whether it is able to be fulfilled under the real-time conditions called for. For example, this check is carried out based on a quality measure which, starting from the original runtime behavior, allows a certain time-pattern loss.

### BRIEF DESCRIPTION OF THE DRAWINGS

Exemplary embodiments of the present invention are explained in greater detail in the following description and represented in the figures.

FIG. 1 shows a flowchart of a method according to a first specific embodiment of the present invention.

FIG. 2 shows the dynamic behavior of two exemplary software components.

FIG. 3 shows schematically an electronic control unit according to a second specific embodiment of the present invention.

### DETAILED DESCRIPTION OF EXAMPLE EMBODIMENTS

The terms “services” and “interfaces” are to some extent used synonymously in the following, since via certain interfaces, corresponding services are developed or made available by the exchange of data.

As part of a system architecture according to the present invention for control programs, this method is used for the communication between various software components of respective systems. The message broker used for this utilizes application programming interfaces (APIs) appropriate for this purpose, and is constantly active insofar as the underlying operating system allows it. The message broker may be implemented with the aid of different technologies, among them MQTT or DDS.

To this end, the message broker is configured in such a way that mutual access protection is ensured. To do this, for example, a separate namespace is assigned to each control program. The message broker possesses a generic part as well as configurations with respect to visibility, etc., adapted to the specific target system. To that end, for example, during the installation process, parts of the manifest may be stored in a registry, based on which in a separate part of the installation process, a configuration of the message broker is generated online on an ECU with and/or without Internet. This configuration would constantly be refreshed as part of a further installation or change of a control program, particularly upon its deinstallation with and/or without Internet connection.

The communication between the aforementioned APIs takes place solely via the message broker. Three types of communication may be differentiated based on the modeling of data and the control flow. These types of communication provided by an abstraction layer of the system architecture and the concrete implementation of the initially abstractly-defined communication are transmitted through the message broker. Differentiated in this case are the type, content, number and combinations of interfaces or their services, as well as operational reliability and data security of the communication channel. In addition, the type of communication may be characterized based on the supported access methods, events and other parameters, e.g., an application rate.

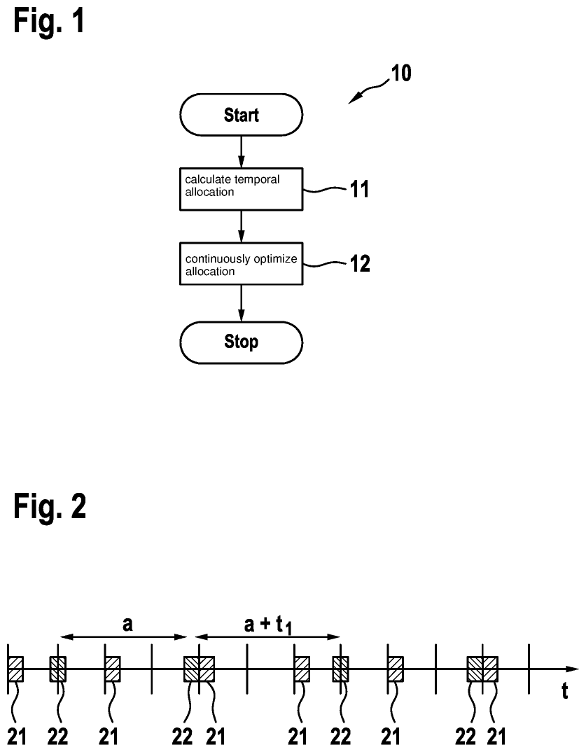

FIG. 1 illustrates a method (10) of access management by a message broker according to the present invention. The need of a software component to access a certain software interface forms the starting point for the following considerations.

In a first phase (process 11), the temporal allocation of the software components to the software interfaces is calculated statically based on the requirements, defined in the respective manifest, with respect to the software interfaces. This may already be carried out during the development. To that end, specified in the manifest of the component in question are its requirements as to type (class), number (value range), reaction times, design model (synchronous or asynchronous), diagnostics and logging as well as security goals. The developer is informed in advance of any limitations of resources or performance; a suitable budgeting is also possible. The predetermined latency in this case may be changeable and may depend, for example, on the speed of the working process or the machine traveling speed, etc.

A corresponding calculation (11) may also be carried out during the installation on the target system. For this, the data of the manifests are aggregated, correlated, plausibilized, analyzed or otherwise further processed and set up or stored. In this step, it is determined if, for example, three services—possibly at the same point in time with the same quality requirements for the worst case—would like to access the same interface. Preferably a rights-oriented access control is carried out, which differentiates between read rights and write rights. The total manifest, created in or by a Cloud and also available in the electronic control unit, informs the message broker of such rights and allows a subscription of interfaces that is billed according to their utilization (pay-per-use).

Optionally, the allocation of requirements and resources is then carried out based on users of buses or communication protocols conventional in the related art, e.g., based on ISOBUS users such as an agricultural sprayer or other conventional systems. From this is obtained the requirements with respect to resource management, resource utilization or load, bandwidth, e.g., of the ISOBUS system, etc.

Generally, this static analysis (11) is unable to take into account any changes at runtime and their effect on functions—think, for instance, about control loops, reaction of the system or of the controlled system or learning functions—, since the runtime behavior of the control programs and their services cannot be assessed at the time of the static analysis. FIG. 2 illustrates this problem in light of a first cyclical message (21) with high requirements with respect to the observance of the clock pulse and a second cyclical message (22) with lower requirements with respect to the response time. In view of the possible conflict between messages (21, 22), second message (22) is preferred. If one looks at the spacings between the individual messages (21 and 22, respectively), it becomes clear that their frequencies fluctuate within the permissible tolerance.

Therefore, in view of the observed and/or simulated and/or prognosticated runtime behavior of the software components, in a second phase (process 12) their allocation is optimized continuously, e.g., according to a possibly simulated or prognosticated “subscriber pattern”. This optimization (12) of the resource distribution assumes that the demands defined by the manifests allow sufficient margins of discretion with respect to the assignment and utilization of resources, e.g., by the indication of intervals instead of fixed values for jitter, calculation grids and reaction times. Within the limits set in this way, the system is able to determine and adjust the allocation independently at runtime.

For such an optimization (12), first of all, the degrees of freedom of the optimizer, which set the boundaries of the solution space, are determined. A cost function may now be defined based on higher-level system goals. For example, reaction times, operational reliability, wear, energy consumption or operating costs (the maximum process speed is obtained from the sampling rate of the system and influences the working time) come into consideration.

The optimization algorithm searches the solution space, delimited in this manner, for solutions that are optimal in terms of the cost function. Depending on the solution space, certain algorithms are unable to terminate and thus find no solution. (In this case, user and developer are informed about the incompatibility of the configuration recognized at runtime.) Upon termination of the algorithm, it supplies a local or global optimum that indicates a best-possible temporal distribution of the resource accesses.

Within the framework of a modular and service-oriented system architecture, the message broker fulfills further functions. Among these are logon and logoff of the services, which are made available through a middleware or by the control programs operated in containers. Interchangeability, alteration and replacement of services are thus made possible at runtime without a restart.

In this connection, different designs are possible on the part of the creator (sender) and user (receiver) of the data, without departing from the scope of the invention.

For example, a component, which would like to offer a service, notifies the message broker by way of advertising that the new service—described by certain meta-information—is able to be provided by the component. The message broker may then make this service known to other components. As part of a logon mechanism, the meta-information of the services obtained from the manifest is evaluated by the message broker, and the concrete communication infrastructure in terms of payload, channel, routing ID, etc. for the proffered service is initialized. This initialization includes a check as to whether the information in question is allowed to be offered according to the manifest. The sender, acting as publisher according to the subscription pattern, transmits the payload and thereby also effectively provides the information of the advertised services. This is recorded in a corresponding registry.

For the purpose of discovery, each component, which as subscriber would like to “subscribe to” a service, so to speak, registers with the message broker. The component receives a return message as to whether corresponding services are available, without receiving the requested information itself. It may be that certain services are potentially available, but are not allowed to be used by the inquiring component.

If several services or several instances of the same service offer the identical topic, then after the discovery, the subscribing control program may select the instances relevant for it. This selection may be made according to a provision implemented in the control program itself or a rule stored in its manifest, according to which the message broker determines the relevant instance automatically.

If a receiver is not settled on the names of a piece of information or of a service, then by designation of the topics, with the aid of a suitable wildcard, all services to which the query applies that are registered with the message broker may be retrieved. Based on this list of hits, the receiver is able to decide which services it would like to subscribe to. The results of a discovery which is nonspecific in this sense may turn out differently for different receivers in view of different access rights.

The services found in this way may now be utilized. To that end, upon each change of the object observed, the receiver receives a push notification concerning it, or its current content (push-update notification). In this case, the push notification that new data are available may be linked to conditions. They may relate to external conditions—e.g., temporal aspects such as the timeliness of the respective date or the state of control program, actuator, sensor or system—or the altered data itself, which may be restricted, for instance, by value intervals, statistical or other mathematical functions.

An implementation of the subscriber pattern in which the receiver retrieves the information of the services at the message broker independently in accordance with predetermined rules is likewise possible. With respect to the routing process described above and the form of the communication channel—particularly with regard to the creation and advertising of the services—dynamic and static routing may be differentiated, with mixed forms also being possible. A static routing may be determined at the time of the development (routing ID in the source code), translation (variable in the source code which is defined during the translation), distribution (configuration file created offline) or bootstrapping (configuration file created online). A discovery is superfluous in this case.

In the case of dynamic routing, the specific service is not made known to the receiver until runtime. For the purposes of the preceding implementation, only a generic description of the service is known. Not until after the discovery does the user have a routing ID, under which its data are available.

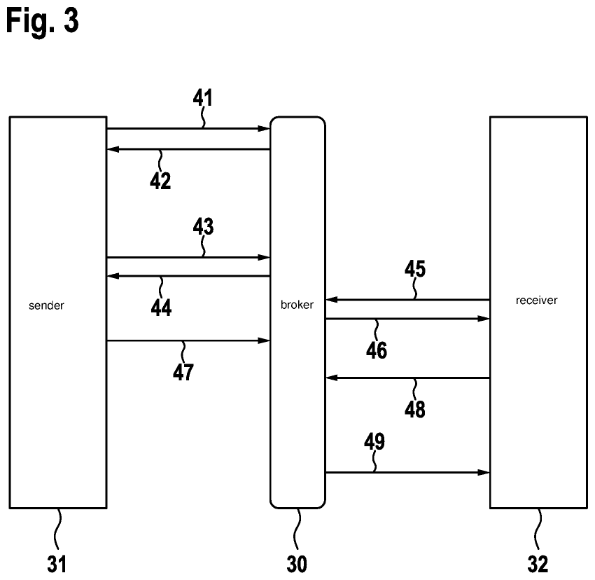

As FIG. 3 illustrates, sender (31) and receiver (32) of certain topics do not have to be active at the same time; thus, a sender (31) does not necessarily need an active receiver (32) and vice versa, since broker (30) is able to store the brokered information temporarily. For example, if a sender (31) announces (41) to broker (30) the provisioning of the topic “speed” and broker (30) acknowledges it as permissible (42), sender (31) may then log on (43) the corresponding service, whereupon, for example, broker (30) assigns the MQTT topic “Auto\Motor\Speed_1” to the generated topic. A discovery (45) concerning the subject “speed” by receiver (32) supplies the information (46) that the speed is available under the topics “Auto\Motor\Speed_1” and “Auto\Motor\Speed filtered”. For example, if sender (31) now publishes (47) the value 1199 min⁻¹ under the topic “Auto\Motor\Speed_1” and receiver (32) subscribes (48) to the topic “Auto\Motor\Speed filtered”, then broker (30) notifies the latter of the pertinent event “1200 min⁻¹” (49).

Such an asynchronous message exchange may follow different rules which may be implemented in the control program itself or defined in its manifest. For example, messages may be erased and the resources tied up by them may be released after a certain number is exceeded, upon capacity utilization of the message buffer used for them, timeout or explicit discard by the user, for instance, upon a fresh logon. For instance, if sender (31) makes 40 data records available one after the other, each with its own timestamp within the framework of a service, then receiver (32) may also retrieve these data later, after sender (31) is no longer available, and optionally evaluate them according to their timestamp.

The logoff of software components is also managed and carried out by message broker (30). Various ways of logging off may be differentiated, depending on urgency. For instance, if because of a crash or for unknown reasons, a control program has failed suddenly and the service provided by it is no longer available, without message broker (30) having been able to prepare for this failure, then this situation causes an immediate logoff. However, if message broker (30) detects that a service is no longer being provided in reliable manner, then this service or the control program furnishing it is forcibly logged off. Finally, if a service used is no longer up-to-date, and a control program initiates the logoff of the service, this logoff may be carried out according to plan.

Depending on the triggering event, the logoff process proceeds as follows: Message broker (30) controls the communication and implements the routing. If message broker (30) detects that a service is no longer available, is unable to provide any satisfactory information, or will no longer be available in the foreseeable future and when it possibly could be available again, then any receivers (32) affected are notified and suitable measures are initiated. The interventions resulting from the measures may involve various dimensions. For example, further dependent services must be logged off in orderly fashion if no replacement services are available. If a replacement service is available or can be made available, the routing must be switched over from the deactivated to the replacing service. In doing so, however, any minimum requirements of receivers (32) with respect to the quality of service (QoS) must be taken into consideration. This consideration and the initiation of further measures if needed are likewise the responsibility of message broker (30).

If a service is shut down or is no longer available for other reasons, then message broker (30) deletes it from the list of available services in the registry. The resources associated with it and possibly dynamically generated metadata for one-time use such as certificates, IDs or passwords lose their validity at the same time. In order to become “visible”, so to speak, for other software components again, the deleted service must re-register and include the metadata indicated above.

Alternatively, each control program decides on its own authority, which services and which service instances it uses. In the case of one corresponding specific embodiment, the routing follows inevitably from this decision. The sender (31) which would like to log off a service notifies message broker (30) with a signal that indicates the logoff of the service within a certain time. It in turn notifies all control programs, which act as receivers (32), about the pending logoff of the service and puts them in the position, if needed, to log on for a suitable replacement service from the registry and thus to set up a new routing. Should no replacement service be available and, based on the aggregated information of the manifests, message broker (30) recognizes that a control program is therefore no longer executable, then with the aid of the responsible system components, it initiates an orderly termination of the control program in question.

In order to ensure the information security of the services in terms of the integrity, authenticity, visibility and readability of the data and to avoid overloading the components by advertising irrelevant for them, their visibility may be controlled on the basis of a white list created with the aid of the manifests. Alternatively, for example, a blacklist of excluded services may be used. To improve the information security, in addition, a transport encryption of the data transfer between message broker (30) and software components is possible. The exchanged contents may be encrypted independently of the transport layer on its part.

1-11. (canceled)

12. A method for managing accesses of multiple software components to software interfaces, the method comprising:
calculating a temporal allocation of the software components to the software interfaces statically based on requirements of the software components with respect to the software interfaces; and
optimizing the allocation continuously in light of an observed and/or simulated and/or prognosticated runtime behavior of the software components.

13. The method as recited in claim 12, wherein:
the allocation is calculated in a development phase of the software components or
the allocation is calculated during installation of the software components.

14. The method as recited in claim 12, wherein the optimization is carried out based on higher-level system goals.

15. The method as recited in claim 14, wherein the system goals relate to at least one of the following:
reaction times,
operational reliability,
wear,
energy consumption,
operating costs.

16. The method as recited in claim 12, wherein accesses to the software interfaces are brokered by a message broker.

17. The method as recited in claim 16, wherein:
the message broker uses MQTT, or
the message broker uses DDS.

18. The method as recited in claim 12, wherein accesses to the software interfaces are carried out according to a subscriber pattern.

19. The method as recited in claim 12, wherein, in response to a failure and/or implausibilities and or insufficient QoS of one of the software components, the one of the software components is logged off and components that are affected are logged off, when no replacement services are available or are not provided.

20. A non-transitory machine-readable storage medium on which a computer program for managing accesses of multiple software components to software interfaces, the computer program, when executed by computer, causing the computer to perform the following steps:
calculating a temporal allocation of the software components to the software interfaces statically based on requirements of the software components with respect to the software interfaces; and
optimizing the allocation continuously in light of an observed and/or simulated and/or prognosticated runtime behavior of the software components.

21. A device configured to manage accesses of multiple software components to software interfaces, the device configured to:
calculate a temporal allocation of the software components to the software interfaces statically based on requirements of the software components with respect to the software interfaces; and
optimize the allocation continuously in light of an observed and/or simulated and/or prognosticated runtime behavior of the software components.
